(19) United States
(12) Patent Application Publication
(10) Pub. No.: US 2014/0253031 A1
(43) Pub. Date: Sep. 11, 2014

(54) WIRELESS BATTERY CHARGING SYSTEM

(71) Applicant: Rolls-Royce Corporation, Indianapolis, IN (US)

(72) Inventor: Robert T. Duge, Carmel, IN (US)

(73) Assignee: ROLLS-ROYCE CORPORATION, Indianapolis, IN (US)

(21) Appl. No.: 14/349,881

(22) PCT Filed: Oct. 8, 2012
(86) PCT No.: PCT/US12/59239

§ 371 Date: Apr. 4, 2014

Related U.S. Application Data
(60) Provisional application No. 61/544,086, filed on Oct. 6, 2011.

(51) Int. Cl. H02J 7/02

(52) U.S. Cl. CPC H02J 7/025
USPC 320/108; 320/137

(57) ABSTRACT

An inductive battery charger is incorporated with a power source that in one embodiment is a genset. A charging surface can be provided that in some forms is hinged, separable, or includes a pocket. In some forms resonant inductive coupling can be used to charge a battery through inductive charging. A battery can be charged within an area such as a perimeter of a military post (e.g. an observation post) using techniques described herein. A battery can also be charged remotely by inductive techniques such as through the use of a passing vehicle, etc.

### CROSS REFERENCE TO RELATED APPLICATIONS

The present application claims the benefit of U.S. Provisional Patent Application 61/544,086, filed Oct. 6, 2012, and is incorporated herein by reference.

### TECHNICAL FIELD

The present invention relates to wireless battery charging systems, and more particularly, but not exclusively, relates to inductive battery charging systems.

### BACKGROUND

Power sources such as generator sets or gensets are used by the military, among others, to provide power in the field for rechargeable batteries used in connection with a variety of devices and equipment. Such batteries have a multitude of different characteristics including, for example, different sizes, different types of connectors, different voltages or other differing electrical characteristics, and may require different types of chargers compatible with the electrical and physical characteristics of each type of battery. FIG. 1 is a schematic diagram of a conventional wired charging system 10. The system 10 includes a genset 12 that generates electrical power. A distribution box 14 is coupled to the genset 12 to receive power from the genset 12. The distribution box 14 may distribute, regulate, and/or control the power to various loads. An extension cord 16 is connected to the distribution box 14. Various chargers 18A, 18B, 18C are connected to the extension cord 16. The chargers 18A, 18B, 18C are connected to and provide power to charge the batteries 20A, 20B, 20C respectively, and have specific electrical and physical characteristics required to recharge their respective batteries. System 10 presents a number of drawbacks and shortcomings including an undesirable need to match batteries with compatible chargers and imposes limits on the number and type of batteries that may be recharged. There is an ongoing demand for further contributions in this area of technology.

### SUMMARY

One embodiment of the present invention includes a unique technique involving inductive battery charging systems. Other embodiments include unique methods, systems, devices, and apparatus involving battery charging systems. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is a schematic diagram of a system 10.

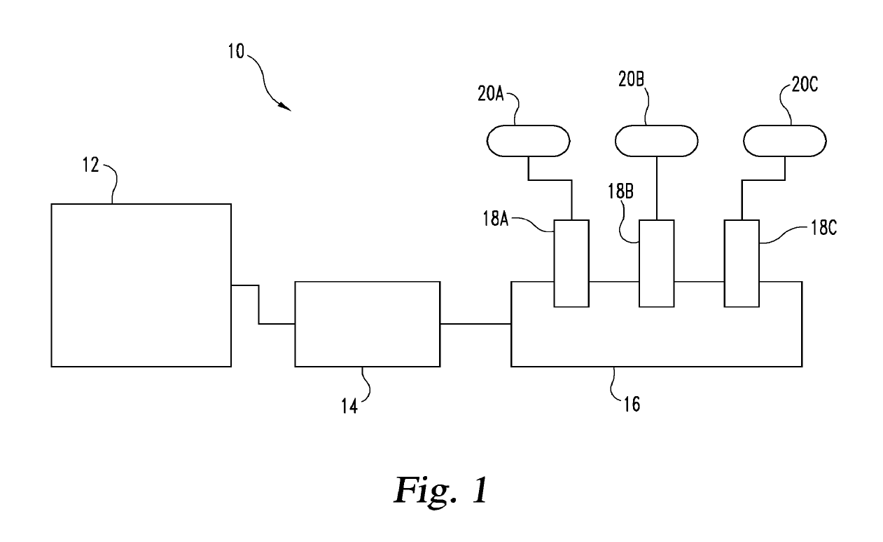

FIG. 2 is a schematic diagram of system 100.

FIG. 3 is a schematic diagram of an inductive device including a charging pocket.

FIG. 4 is a schematic diagram of an inductive device including a top surface of a genset.

FIG. 5 is a schematic diagram of an expandable inductive device.

FIG. 6 is a schematic diagram of another embodiment of an expandable inductive device.

FIG. 7 is a schematic diagram of another embodiment of an expandable inductive device.

FIG. 8 is a schematic diagram of an inductive device around a perimeter of a predetermined area.

FIG. 9 is a schematic diagram of an inductive device in various vehicles.

FIG. 10 is a schematic flow diagram of a procedure for charging a battery.

FIG. 11 illustrates various devices having a rechargeable battery.

FIG. 12 illustrates various devices having a rechargeable battery.

FIG. 13 illustrates the number of rechargeable batteries used by a rifle company.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In one aspect of the present application, an inductive battery charger is integrated with a genset. Generally, inductive battery chargers do not require a specific cord or connector to charge the battery. In one embodiment, a plate charging surface is coupled to the genset. The charging surface includes an inductor that generates a magnetic field. One or more batteries may be laid on the plate. Charging power is provided through the magnetic field to the battery. Additional and/or alternative aspects include other wireless chargers utilizing techniques such as resonant inductive coupling, capacitive coupling and others. It is contemplated that these and other techniques could also be used in connection with the wireless charging systems as described herein.

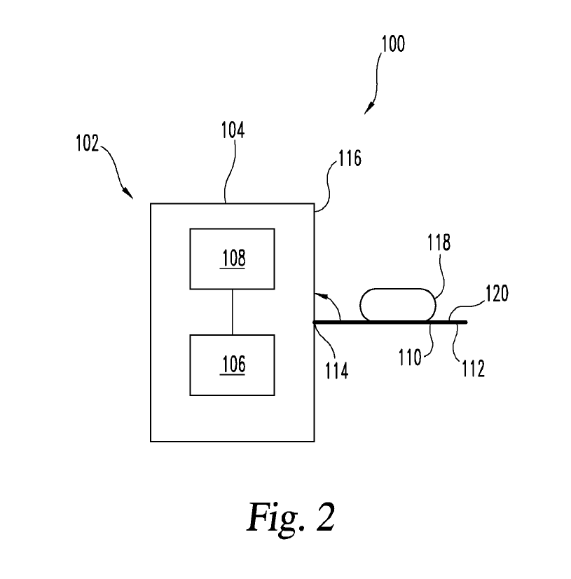

FIG. 2 is a schematic diagram of a battery charging system 100. The system includes a power source 102. In the illustrated embodiment, the power source includes a genset 104. In another embodiment, the power source 102 provides power from an electrical grid or network such as a public grid. The genset 104 includes a generator 106 driven by an internal combustion engine 108. The generator 106 may be any type of generator 106 including, but not limited to, AC generators such as permanent magnet alternators. The internal combustion engine 108 may be any type of engine including diesel, gasoline, natural gas, gas turbine, microturbine, or any other type of engine or power plant.

An inductive device 110 is coupled to the power source 102. The inductive device 110 may be any type of component that includes an inductor. In one embodiment, the inductive device 110 includes one or more inductive charging plates 112 that are electrically coupled to an output 114 of the genset 104. In certain embodiments the inductive charging plate 112 may be physically integrated with the output 114 of the genset 104. The charging plate 112 may fold down from a side 116 of the genset 104. In some forms the charging plate 112 may be folded up for transportation of the genset 104 if appropriate. The charging plate 112 can be folded through the use of a hinge, such as through a piano hinge, living hinge, etc. As will be understood, other locations and positions of the inductive device 110 are also contemplated and can be used.

One or more battery packs 118 may be placed in contact or in close proximity to a charging surface 120 of the inductive device 110. The battery pack 118 generally includes a battery cell, and can be configured and/or have an inductor, and associated circuitry. The inductor and associated circuitry may be integral with the battery pack or may be part of a sleeve or cover that connects to the battery pack 118. Power, such as AC power, from the genset 104 is provided to the inductive device 110, which generates a magnetic field (not shown). The magnetic field from the inductive device 110 couples with an inductor in the battery pack to induce a current in the battery pack 118 to charge the battery cell. The circuitry in the battery pack 118 may control or regulate the current from the inductor to charge the battery cell. In another embodiment, a capacitive coupling occurs between the battery pack 118 and the inductive device 110.

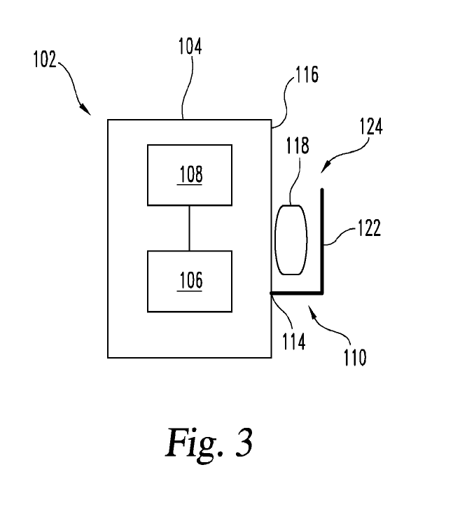

FIG. 3 illustrates another embodiment of the present application including a number of features described above in connection with FIG. 2 indicated with the same reference numerals used in connection therewith. In FIG. 3, the genset 104 includes a charging pocket 122 having a slot 124 that allows one or more battery packs 118 to be inserted into the pocket 122. The pocket can be any size and configuration and in one form includes one or more lateral stops and a bottom to keep the one or more battery packs 118 confined. The inductive device 110 may be part of the charging pocket 122 and/or the side 116 of the genset 104 among other possible locations. Battery packs 118 placed in the charging pocket 122 are charged.

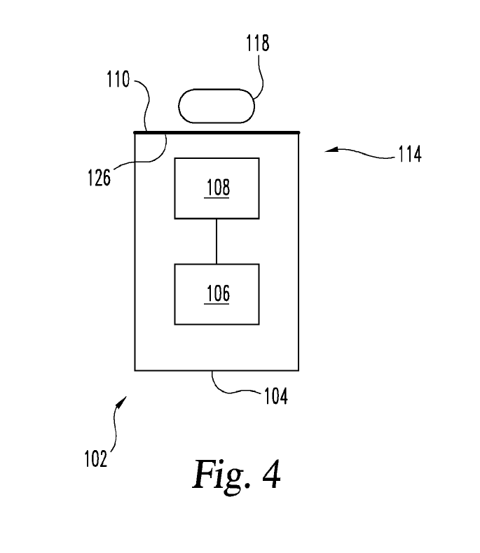

FIG. 4 illustrates another embodiment of the present application including a number of features described above in connection with FIG. 2 indicated with the same reference numerals used in connection therewith. In FIG. 4, a top surface 126 of the genset 104 includes the inductive device 110. Battery packs 118 placed on the top surface 126 will be charged by the magnetic field generated by the inductive device 110.

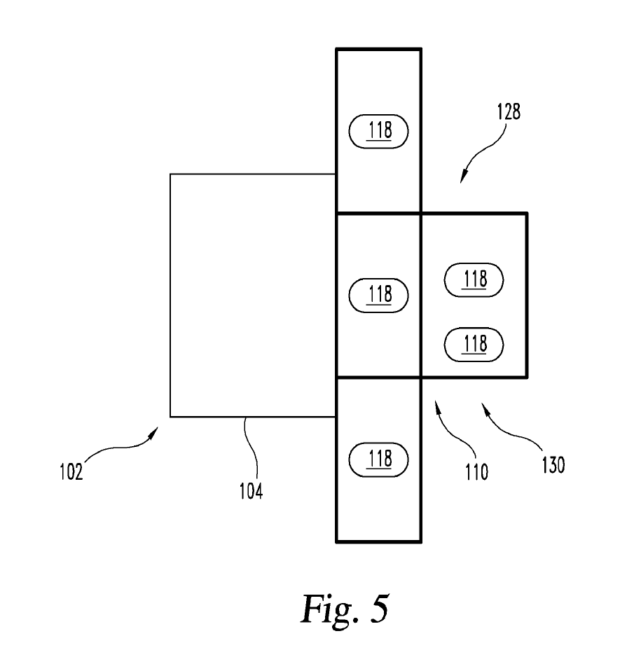

FIGS. 5-7 illustrate additional embodiments of the present application in which a charging surface 120 of the inductive device 110 may be expanded at the point of deployment to allow charging space for the maximum number of battery packs 118 including a number of features described above in connection with FIG. 2 indicated with the same reference numerals used in connection therewith.

FIG. 5 is a top view that illustrates another embodiment of the present application in which a charging plate 128 is expandable, for example by adding or unfolding one or more sections 130, to accommodate additional battery packs 118. For example, the charging plate 128 may have four sections that may be folded or collapsed for storage, such as when the genset 104 is in transit.

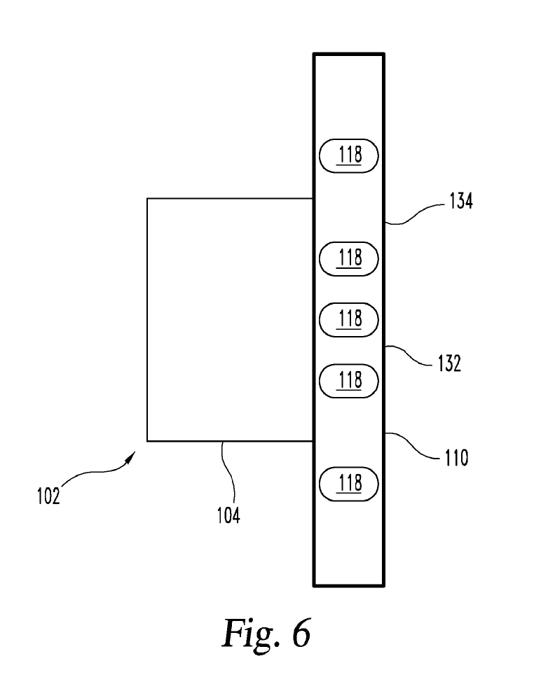

FIG. 6 is a top view that illustrates another embodiment of the present application in which a charging pocket 132 is expandable, for example by adding sections 134 of different dimensions, to accommodate more battery packs 118. Additionally, the charging pocket 132 may have multiple sections that may be folded or collapsed for storage, for example when the genset 104 is in transit.

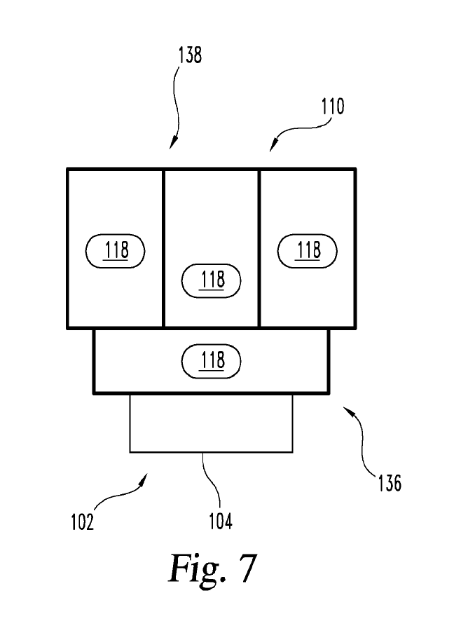

FIG. 7 is a top view that illustrates another embodiment of the present application in which a top surface 136 of the genset 104 is expandable, for example by unfolding or adding one or more sections 138, to accommodate more battery packs 118. For example, the top surface 136 may have multiple sections that may be folded or collapsed or removed for storage, such as when the genset 104 is in transit.

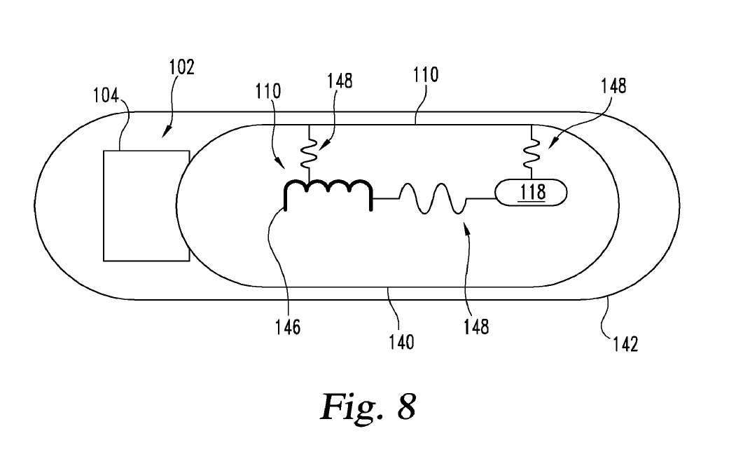

FIG. 8 illustrates another embodiment of the present application in which resonant inductive coupling can be used to increase the effective range of inductive charging. Ranges of several feet or more between an inductive device and a battery are possible. Magnetic fields are passed between two coils having a common resonant frequency to provide power to the inductive device or the battery. Using this configuration, batteries could be wirelessly charged within a predetermined area such as a perimeter of a military base or a floor or room of an office building or home. One embodiment of resonant inductive coupling includes a coil placed in the ground/floor/walking surface/etc of a predetermined area that in some instances is demarcated as such. One such predetermined area is a perimeter of an area, a room, etc. In some forms the perimeter could be the perimeter of a military designated area such as an observation post, etc. where soldiers come and go as they conduct their duties. Such a demarcated area can have explicit markings that set the area apart and/or that serve to guide an individual, etc to approach it so that a battery can be recharged. In some forms the predetermined area need not be visually marked but otherwise marked in the sense that some type of communication (verbal, written, etc) sets forth the predetermined area. Finally, it will be appreciated that any of the embodiments described herein can operate on the basis of resonant inductive coupling.

In the illustrated embodiment of FIG. 8, the inductive device 110 includes a transmit coil 140 that is provided within an outer perimeter 142 of a predetermined area, with all battery packs 118 within the perimeter 142 being able to be recharged. The transmit coil 140 may be one large coil or network of smaller coils that generate a magnetic field in the predetermined area. The transmit coil 140 receives power from the genset 104 to generate a magnetic field inside perimeter 142. The magnetic field resonantly couples with the inductor in the battery pack 118 as indicated by magnetic field couplings 148 to induce a current in the battery pack 118 to charge the battery cell. It is contemplated that an individual may not have to remove the battery pack 118 from the electronic device (e.g., a flashlight, cell phone, radio, etc.) to charge the battery pack 118. This would allow the person to continue performing his or her normal duties within the predetermined area.

It is contemplated that a relatively lightweight receiving coil 146 may be provided on a person such as on the person's clothing or in the case of a soldier, on the soldier's helmet, uniform, or equipment. The receiving coil 146 acts as a local repeater to transmit power to the inductors in the battery packs 118 that are carried by the person. In particular, the receiving coil 146 receives power from an inductive device 110 through a magnetic field and transmits power to a battery pack 118 through a magnetic field. In this way, the receiving coil is another inductive device 110.

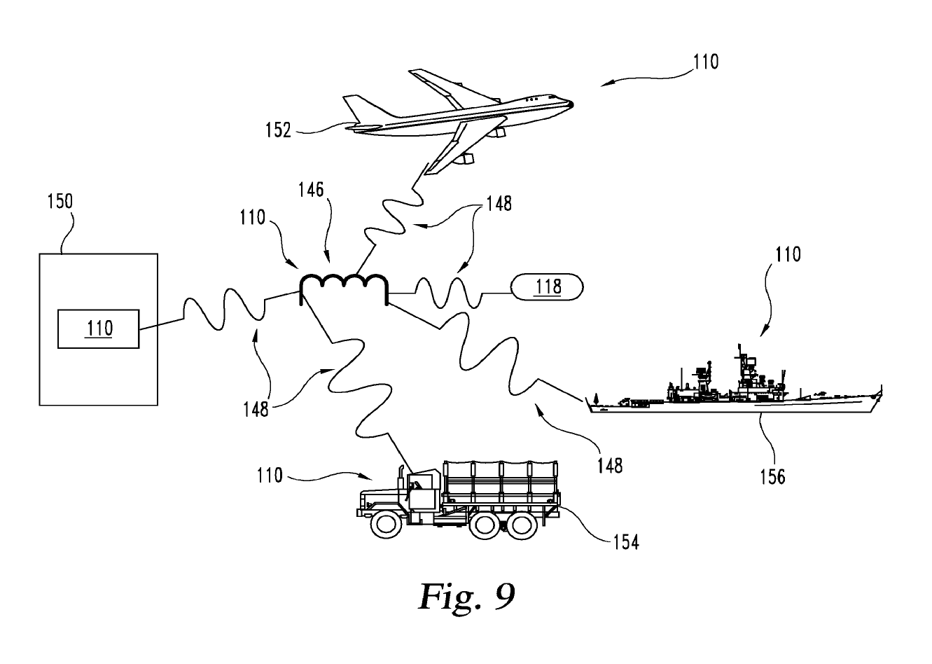

As illustrated in FIG. 9, power could be transmitted, using an inductive device 110, to a battery pack 118 or receiving coil 146 from a remote location 150, or a vehicle such as an aircraft 152, truck 154, or ship 156, eliminating the need for the person, such as a soldier, to carry a generator or fuel. An internal combustion engine can be used in any of these situations to provide power to the inductive device 110. Furthermore, the internal combustion engine can be associated with a genset or can be used as a power plant for any variety of vehicles. The person may use a receiving coil 146 to improve charging range. Furthermore, it is contemplated that a person may ride with the inductive charging system in one or more of the moving vehicles (land, air, sea) 150 so that a person's, such as a soldier's, battery powered gear will be charged when he or she arrives at the destination and dismounts from the vehicle 150. It is contemplated that any of the inductive devices 110 may couple with the receiving coil 146 or the inductor in the battery pack 118.

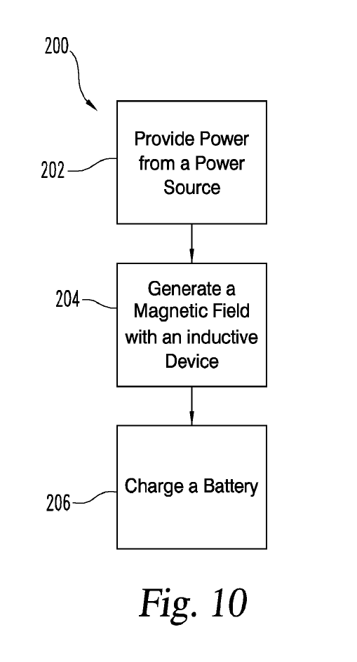

FIG. 10 shows a schematic flow diagram 200 for charging a battery. Operations illustrated are understood to be examples only, and operations may be combined or divided, and added or removed, as well as re-ordered in whole or in part, unless explicitly stated to the contrary. In operation 202, power is provided from a power source 102, such as a genset 104, to an inductive device 110. In operation 204, the inductive device 110 generates a magnetic field as current flows through the inductive device 110. In operation 206, a battery pack 118 is charged by placing the battery pack 118 in contact or in close proximity to the inductive device 110 such that the battery pack 118 is within the magnetic field generated by the inductive device 110.

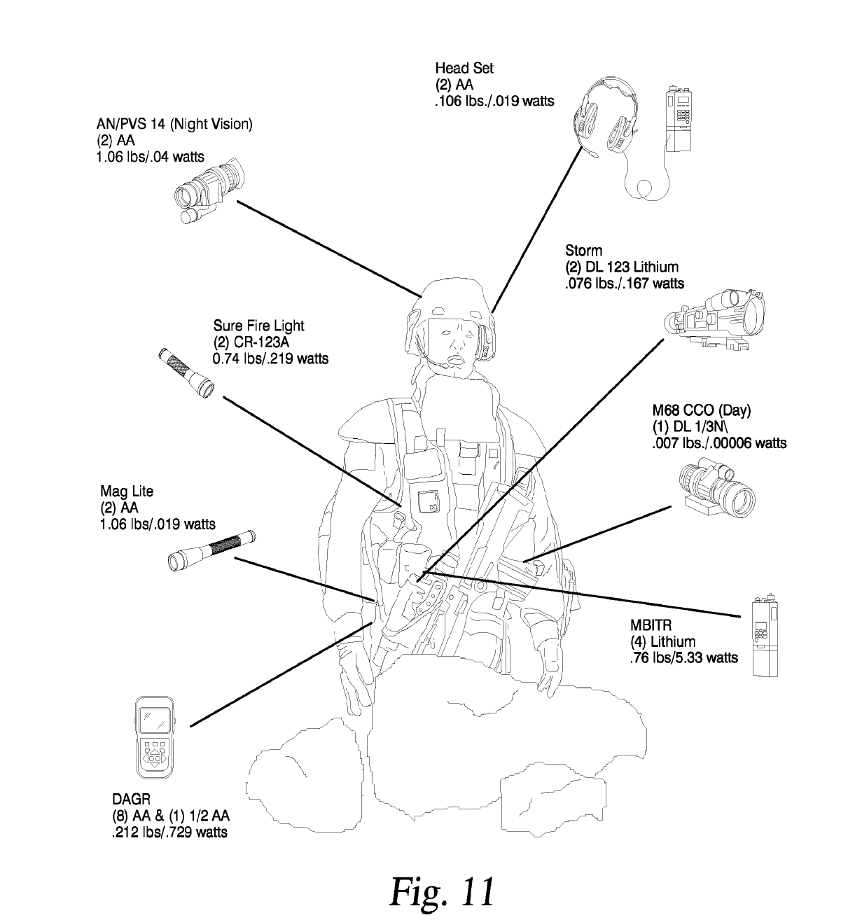

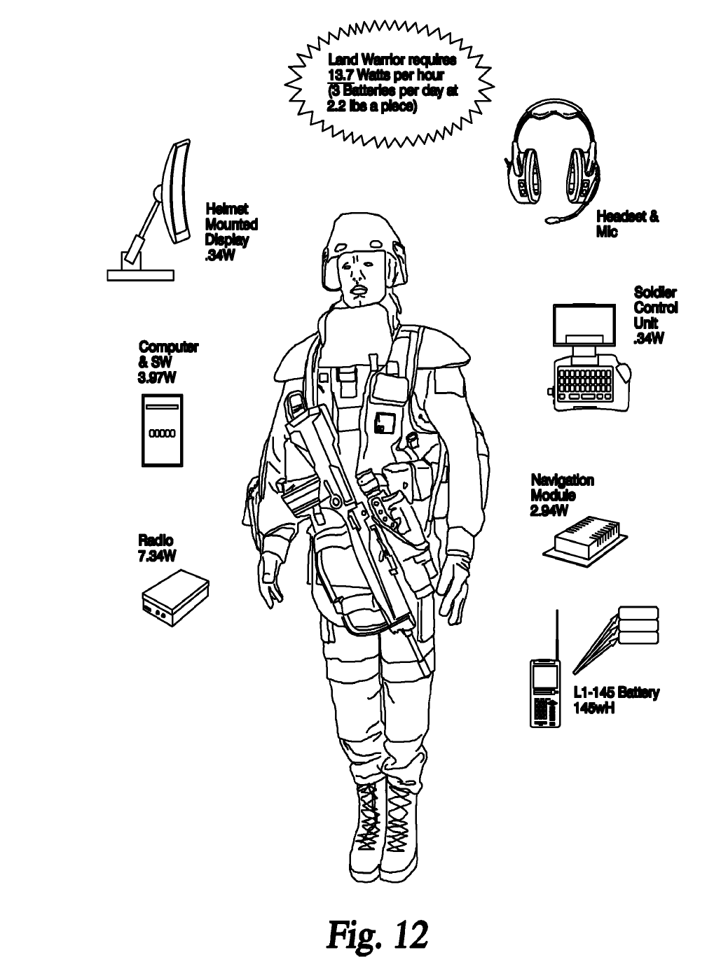

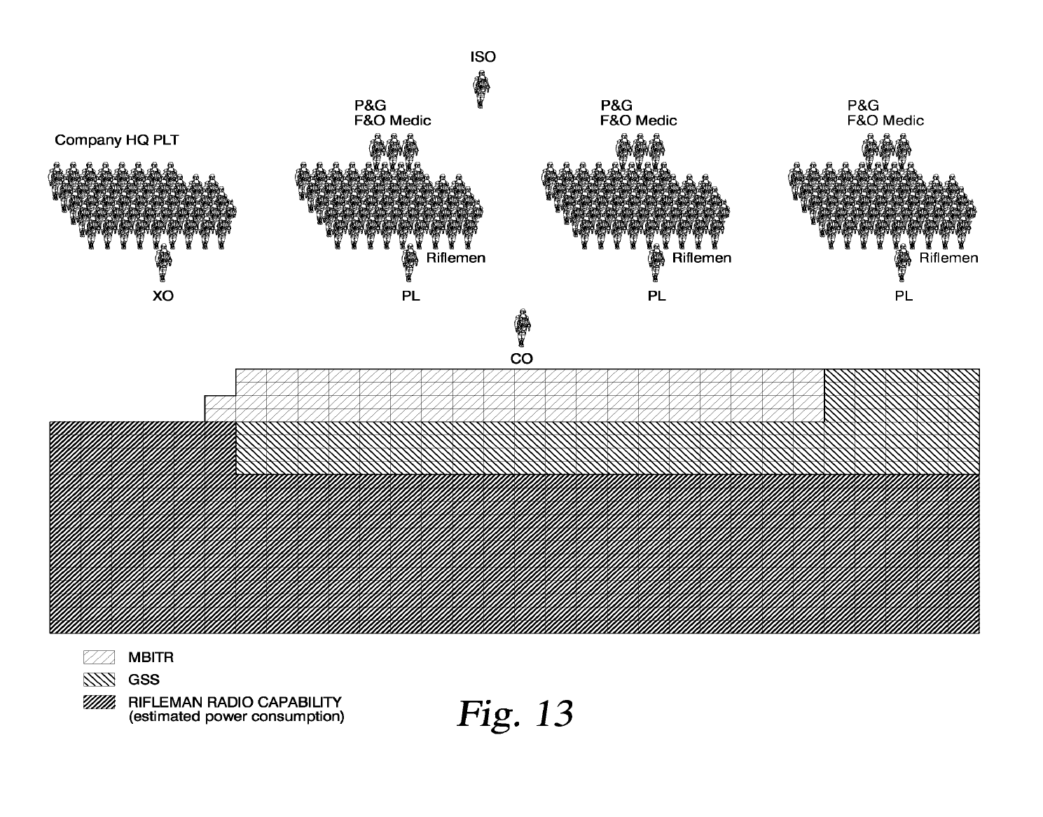

Embodiments of the present application may include one or more of the following features which may allow individuals, such as soldiers, to avoid several cost, weight, space, and safety issues. For example, soldiers may not have to carry a variety of electrical interconnection devices (distribution boxes, extension cords, and individual chargers) to charge the various types of batteries. FIGS. 11-13 illustrate that a rifle company may use physical chargers plus distribution equipment for 578 batteries. The weight and space of that equipment may be eliminated with the present application. Furthermore, inductive chargers generally use magnetic fields, rather than electric fields. Magnetic fields generally have been found to have minimal effects on living organisms. In addition, there are no exposed conductors, as can occur with electrical field devices.

One aspect of the present application includes an apparatus, comprising: a power source; and an inductive device coupled to the power source, wherein the inductive device is structured to generate a magnetic field to charge a battery.

Features of the aspect may include: the power source comprises a genset; the genset comprises a generator driven by an internal combustion engine; the inductive device comprises a surface to be selectively folded-down from the power source; the inductive device comprises a pocket on the power source; the inductive device is integral with a top surface of the power source; the inductive device is expandable; the inductive device comprises a transmit coil; the transmit coil is located generally along a perimeter of a predetermined area; a receiving coil structured to receive power from the inductive device through the magnetic field, wherein the receiving coil is further structured to charge the battery; a vehicle carrying the power source and inductive device; the vehicle is an aircraft.

Another aspect of the present application includes a method, comprising: providing power from a power source; coupling an inductor to the power source to receive power; and charging a battery with power from the inductor.

Features of the aspect may include: carrying the power source and the inductive device with a vehicle; receiving power from the inductive device with a receiving coil, and charging the battery with power from the receiving coil; placing the inductive device around the perimeter of a predetermined area.

Another aspect of the present application includes a system, comprising: a genset to generate electrical power; an inductive device coupled to the genset, the inductive device structured to generate a magnetic field; and a plurality of batteries located within the magnetic field.

Features of the aspect may include: the genset is located on a vehicle; a receiving coil to repeat the magnetic field to charge the batteries; the inductive device includes means for charging the batteries within a predetermined area.

Still another aspect of the present application include an apparatus, comprising a charging base unit configured to include an inductive device useful for providing a magnetic field that can be used to inductively charge a battery and configured to receive power from a power source, the base unit further including an expanding surface structured to withstand the weight of the battery when the battery is placed upon the expanding surface for a charging operation wherein the inductive device is structured to generate a magnetic field to charge the battery.

A feature of the present application further includes the power source disposed with the charging base unit, and wherein the power source comprises a genset.

Another feature of the present application provides wherein the genset comprises a generator driven by an internal combustion engine.

Yet another feature of the present application further includes a vehicle carrying the power source and inductive device.

Still yet another feature of the present application provides wherein the expanding surface includes a hinge structured such that the expanding surface can be selectively folded-down from the base unit.

Yet still another feature of the present application provides wherein the expanding surface includes the inductive device.

A further feature of the present application provides wherein the expanding surface is a separable surface that can be selectively added and removed from the base unit.

A still further feature of the present application provides wherein the inductive device is disposed within the expanding surface.

Yet another aspect of the present application provides an apparatus, comprising a charging base unit configured to include an inductive device useful for providing a magnetic field that can be used to inductively charge a battery and configured to receive power from a power source, the base unit further including a pocket structured to capture the battery for a charging operation, wherein the inductive device is structured to generate a magnetic field to charge the battery.

A feature of the present application further includes the power source disposed with the charging base unit, and wherein the power source comprises a genset.

Another feature of the present application provides wherein the genset comprises a generator driven by an internal combustion engine.

Still another feature of the present application provides further includes a vehicle carrying the power source and inductive device.

Yet still another aspect of the present application provides a method, comprising combusting fuel in an internal combustion engine associated with a vehicle, driving an electrical generator through power developed as a result of operating the internal combustion engine, generating a magnetic field using an inductor powered by the electrical generator, and inductively charging a battery with power from the inductor.

A further feature of the present application provides carrying the internal combustion engine and the battery with a vehicle.

Another feature of the present application provides moving a vehicle that includes the internal combustion engine, and receiving the magnetic field by a user that is external to the vehicle.

Still another feature of the present application provides placing the inductor around the perimeter of a predetermined area.

A still further aspect of the present application provides a method, comprising operating an engine to produce mechanical power, receiving the mechanical power to an electrical generator to generate electrical power, flowing current through an inductor to produce a magnetic field, locating an inductive battery charger within a demarcated battery charger transit area sized to receive a transiting person, and receiving the magnetic field with the inductive battery charger to charge a battery.

One feature of the present application provides wherein the flowing occurs around a perimeter of a military operations area.

Another feature of the present application provides moving a vehicle that includes the internal combustion engine, and receiving the magnetic field by a user that is outside of the vehicle.

Still another feature of the present application provides placing the inductor around the perimeter of a predetermined area.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. An apparatus, comprising:
a charging base unit configured to include an inductive device useful for providing a magnetic field that can be used to inductively charge a battery and configured to receive power from a power source, the base unit further including an expanding surface structured to withstand the weight of the battery when the battery is placed upon the expanding surface for a charging operation;
wherein the inductive device is structured to generate a magnetic field to charge the battery.

2. The apparatus of claim 1, which further includes the power source disposed with the charging base unit, and wherein the power source comprises a genset.

3. The apparatus of claim 2, wherein the genset comprises a generator driven by an internal combustion engine.

4. The apparatus of claim 2, which further includes a vehicle carrying the power source and inductive device.

5. The apparatus of claim 1, wherein the expanding surface includes a hinge structured such that the expanding surface can be selectively folded-down from the base unit.

6. The apparatus of claim 5, wherein the expanding surface includes the inductive device.

7. The apparatus of claim 1, wherein the expanding surface is a separable surface that can be selectively added and removed from the base unit.

8. The apparatus of claim 6, wherein the inductive device is disposed within the expanding surface.

9. An apparatus, comprising:
a charging base unit configured to include an inductive device useful for providing a magnetic field that can be used to inductively charge a battery and configured to receive power from a power source, the base unit further including a pocket structured to capture the battery for a charging operation;
wherein the inductive device is structured to generate a magnetic field to charge the battery.

10. The apparatus of claim 9, which further includes the power source disposed with the charging base unit, and wherein the power source comprises a genset.

11. The apparatus of claim 10, wherein the genset comprises a generator driven by an internal combustion engine.

12. The apparatus of claim 10, which further includes a vehicle carrying the power source and inductive device.

13. A method, comprising:
combusting fuel in an internal combustion engine associated with a vehicle;
driving an electrical generator through power developed as a result of operating the internal combustion engine;
generating a magnetic field using an inductor powered by the electrical generator; and
inductively charging a battery with power from the inductor.

14. The method of claim 13, further comprising:
carrying the internal combustion engine and the battery with a vehicle, the vehicle is an aircraft.

15. The method of claim 13, further comprising:
moving a vehicle that includes the internal combustion engine; and
receiving the magnetic field by a user that is external to the vehicle.

16. The method of claim 13, further comprising:
placing the inductor around the perimeter of a predetermined area.

17-20. (canceled)

21. The method of claim 13, further comprising placing the battery in close proximity to the magnetic field.

22. The method of claim 13, wherein the step of generating a magnetic field includes flowing current through the inductor.

23. The method of claim 13, further comprising locating an inductive battery charger within a transit area.

24. The method of claim 13, wherein the step of inductively charging includes simultaneously charging the batteries that are being carried by a plurality of service men.
